(19) United States
(12) Patent Application Publication
(10) Pub. No.: US 2016/0115727 A1
(43) Pub. Date: Apr. 28, 2016

(54) OPENING/CLOSING MECHANISM EQUIPPED WITH A SELF-LOCK DEVICE

(71) Applicant: QINGDAO SIFANG ROLLING STOCK RESEARCH INSTITUTE CO., LTD., QINGDAO (CN)

(72) Inventors: HUI LIU, QINGDAO (CN); KUN WANG, QINGDAO (CN); KAI CHEN, QINGDAO (CN); HE ZHANG, QINGDAO (CN); QUAN LIU, QINGDAO (CN); HUI HUANG, QINGDAO (CN); XUDONG LIU, QINGDAO (CN)

(21) Appl. No.: 14/991,907

(22) Filed: Jan. 8, 2016

Related U.S. Application Data
(63) Continuation-in-part of application No. PCT/CN2013/087112, filed on Nov. 14, 2013.

(30) Foreign Application Priority Data
Oct. 18, 2013 (CN) 201310493600.1

(51) Int. Cl. E06B 3/32; B61C 17/00; E05F 15/00

(52) U.S. Cl. CPC E06B 3/325; E05F 15/00; B61C 17/00; E05Y 2900/51

(57) ABSTRACT

The present invention relates to an opening/closing mechanism equipped with a self-lock device; the opening/closing mechanism includes a baseplate(1), a fairing(2), a fairing support arm(3), and a powered push cylinder(4); wherein the baseplate(1) is provided with a rotating shaft(5), one end of the fairing support arm(3) is sleeved on the rotating shaft(5), while the other end is connected with the fairing(2) by means of a fairing mounting base(6); the baseplate(1) is provided with a closed-state limit stop(7) and an open-state limit stop(8); a locking device(9) is arranged between the fairing support arm(3) and the powered push cylinder(4), one end of the said locking device(9) can move in the sliding groove of the fairing support arm(3), while the other end is installed on the powered push cylinder(4). The invention is simple and reliable in structure, low in cost, high in stability, and convenient for examination and repair. A power source is used for realization of opening and closing of the opening/closing mechanism, mechanical self-lock is achieved by means of over “dead point” for locking the opening/closing mechanism so as to hold at established state without additional power sources.

### CROSS-REFERENCE TO RELATED APPLICATION

This application is a continuation-in-part application of, and claims the priority benefit of International Application No. PCT/CN2013/087112 filed on Nov. 14, 2013, which in turn claims the priority benefits of China patent application No. 201310493600.1 filed on Oct. 18, 2013. The contents of these prior applications are hereby incorporated by reference in their entirety.

### FIELD OF THE INVENTION

The present invention relates to the field of railway vehicle mechanical manufacturing technology, in particular to a front-end opening/closing mechanism of a CRH train.

### BACKGROUND OF THE INVENTION

In order to realize reconnection or return rescue, usually a front-end opening/closing mechanism is simultaneously installed at both ends of a CRH train. As an important part of a CRH train, the front-end opening/closing mechanism is at a closed state during normal running (i.e. at a non-reconnection state) of the CRH train, during this time, a front-end fairing cabin door is closed so as to prevent vanes, dust, ice and snow from entering and to protect the coupler and other facilities in the front-end fairing, ensuring a good aerodynamic profile of the CRH train. in case of return or rescue, the opening/closing mechanism can be either automatically opened or manually opened, thus opening the front-end fairing cabin door and revolving it into the front end, the full-automatic coupler is stretched out for normal coupling.

At present, a familiar front-end opening/closing mechanism usually consists of a pushing device and a locking device. In order to achieve opening and closing the opening/closing mechanism and realize a reliable locking, the opening/closing mechanism usually is provided with one or several independent locking devices. Consequently, the opening-closing process and the locking process of the opening/closing mechanism usually are achieved by different operations, which require two or more different air cylinders, resulting in comparatively complex mechanical structure and automatic control theory of the opening/closing mechanism, as well as correspondingly higher cost and lower reliability.

### SUMMARY OF THE INVENTION

In allusion to above-mentioned disadvantages (more complex structure and higher cost, etc.) of the existing opening/closing mechanism at the front-end of a CRH train, the present invention provides an opening/closing mechanism equipped with a self-lock device, which is simple and reliable in structure, convenient for examination and repair, and low in cost.

The technical solution of the invention is as below: an opening/closing mechanism equipped with a self-lock device, comprising a baseplate, a fairing, a fairing support arm, and a powered push cylinder; wherein the baseplate is provided with a rotating shaft, one end of the fairing support arm is sleeved on the rotating shaft, while the other end is connected with the fairing by means of a fairing mounting base; the baseplate is provided with a closed-state limit stop and an open-state limit stop; a locking device is arranged between the fairing support arm and the powered push cylinder, one end of the said locking device can move in the sliding groove of the fairing support arm, while the other end is installed on the powered push cylinder; in the opening or closing process of the opening/closing mechanism, the locking device moves and forms a mechanism dead point with the fairing support arm; in the locking process, a part of the locking device goes across the mechanism dead point and is mechanically limited, and in the unlocking process, the locking device goes across the mechanism dead point from reversed direction.

Preferentially, the locking device comprises a cylinder body, in which a rolling wheel assembly and a spring are precompressed.

Preferentially, the one end of the cylinder body precompressed with a rolling wheel assembly is in rolling connection with the fairing support arm by means of the rolling wheel assembly, the rolling wheel assembly can roll in the fairing support arm, while the other end of the cylinder body is connected with the powered push cylinder.

Or instead, the one end of the cylinder body precompressed with a rolling wheel assembly is in rolling connection with the fairing support arm by means of the rolling wheel assembly, the rolling wheel assembly can roll in the fairing support arm, while the underneath of the wheel of the rolling wheel assembly is connected with the powered push cylinder.

Further, the lower end of the cylinder body is provided with a connector for manual unlocking and manual locking, both of which are operated through the connector.

Preferentially, only one rotating shaft is positioned, which is in the center of the baseplate.

Preferentially, two rotating shafts are positioned, which are on both sides of the baseplate.

The advantageous effects of the invention: the present invention is simple and reliable in structure, low in cost, high in stability, and convenient for examination and repair; a power source is used for realization of opening and closing of the opening/closing mechanism, mechanical self-lock is achieved by means of over “dead point” for locking the opening/closing mechanism so as to hold at an established state; the present invention achieves opening and closing by one action, and simultaneously realizes the locking function of the opening/closing mechanism without additional power sources, changing the fact that additional locking devices and power sources are required for realization of the locking function of the previous opening/closing mechanism, and simplifying the structure of the opening/closing mechanism on the basis of realization of the locking function of the opening/closing mechanism. In addition, the lower end of the cylinder body of the locking device in the present invention is provided with a connector for manual unlocking and manual locking, both of which are operated through the connector simply; the manual unlocking and locking of the opening/closing mechanism can be achieved by revolving the locking device by an Allen wrench.

### BRIEF DESCRIPTION OF THE DRAWINGS

FIG. 1 is a structure diagram of the opening/closing mechanism in embodiment 1 of the present invention.

FIG. 2 is a schematic diagram of the opening/closing mechanism at the open-state in embodiment 1 of the present invention.

FIG. 3 is an A-A sectional drawing of FIG. 2 in embodiment 1 of the present invention.

FIG. 4 is a schematic diagram of the opening/closing mechanism at the closed-state in embodiment 1 of the present invention.

### DETAILED DESCRIPTION OF THE EMBODIMENTS

Further description of the invention is made in combination with the accompanying drawings.

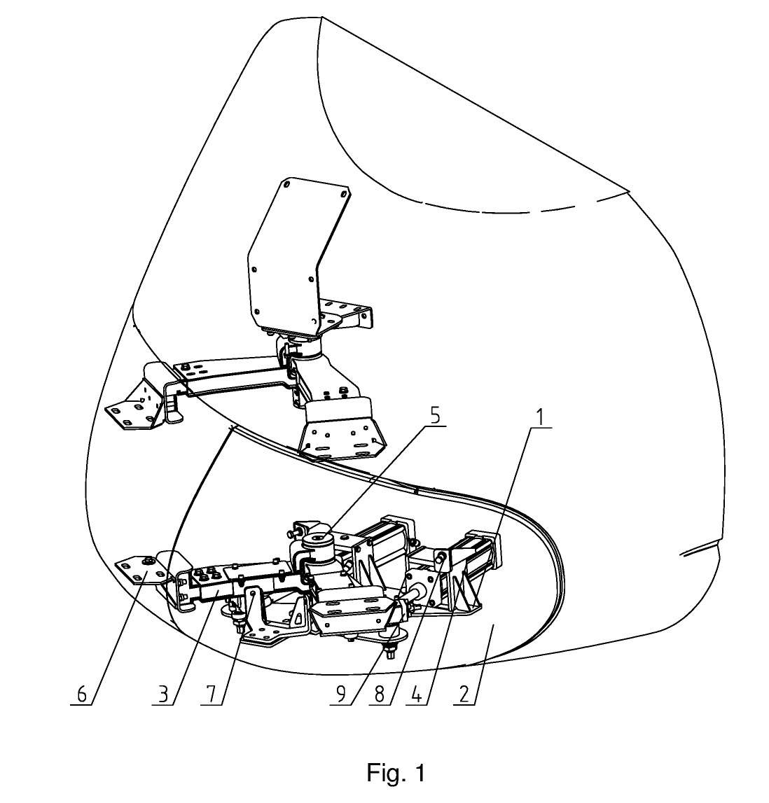

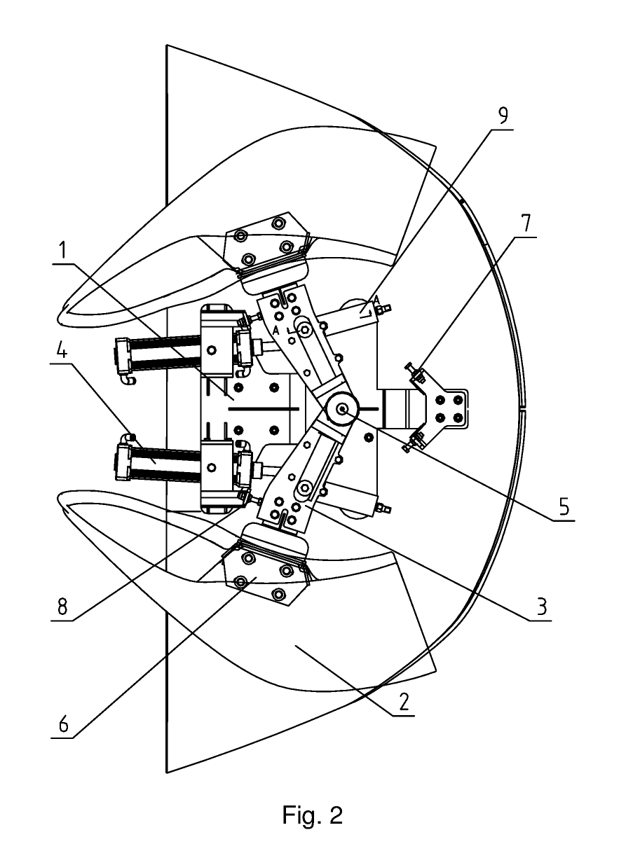

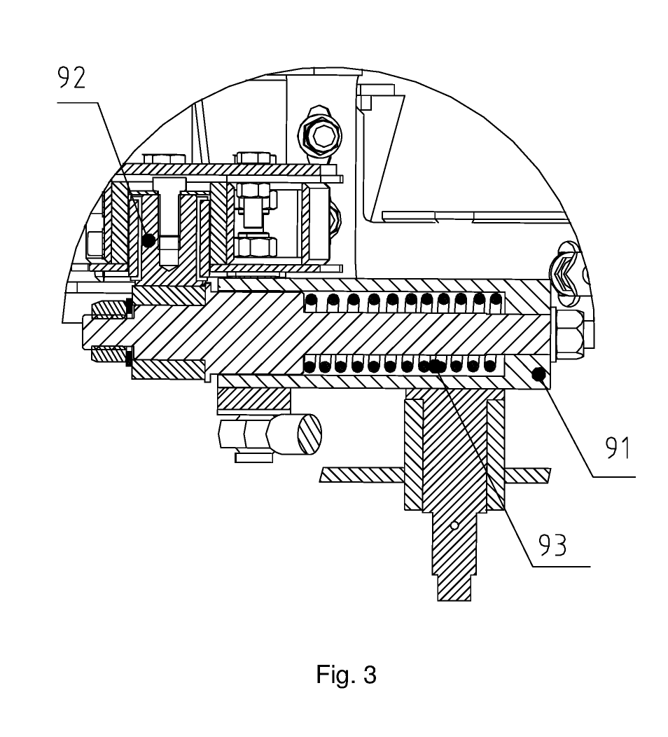

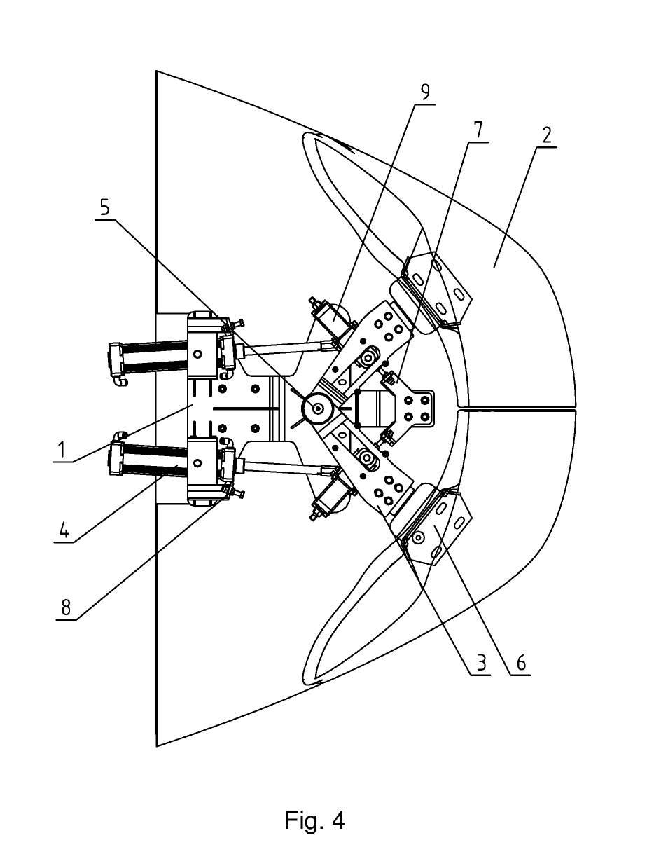

Embodiment 1: as shown in FIGS. 1-4, an opening/closing mechanism equipped with a self-lock device, comprising a baseplate 1, a fairing 2, a fairing support arm 3, and a powered push cylinder 4; wherein the baseplate 1 is provided with a rotating shaft 5, one end of the fairing support arm 3 is sleeved on the rotating shaft 5, while the other end is connected with the fairing 2 by means of a fairing mounting base 6; the baseplate 1 is provided with a closed-state limit stop 7 and an open-state limit stop 8; a locking device 9 is arranged between the fairing support arm 3 and the powered push cylinder 4, one end of the said locking device 9 can move in the sliding groove of the fairing support arm 3, while the other end is installed on the powered push cylinder 4; in the opening or closing process of the opening/closing mechanism, the locking device 9 moves and forms a mechanism dead point with the fairing support arm 3; in the locking process, a part of the locking device 9 goes across the mechanism dead point and is mechanically limited, and in the unlocking process, the locking device 9 goes across the mechanism dead point from reversed direction.

For realization of the rolling connection between the locking device 9 and the fairing support arm 3 and giving play to self-locking function, the locking device 9 comprises a cylinder body 91, in which a rolling wheel assembly 92 and a spring 93 are precompressed; one end of the cylinder body 91 precompressed with the rolling wheel assembly 92 is in rolling connection with the fairing support arm 3 by means of the rolling wheel assembly 92, the rolling wheel assembly 92 can roll in the fairing support arm 3, while the other end of the cylinder body 91 is connected with the powered push cylinder 4.

The working principle of the locking device 9 for realization of self-lock is as below: driven by the powered push cylinder 4, the locking device 9 can rotate around the baseplate 1, the rolling wheel assembly 92 at the other end of the locking device 9 can roll in the fairing support arm 3, simultaneously driving the fairing support arm 3 to rotate around the rotating shaft 5; when the fairing 2 rotates to the open or closed-state, which is driven by the fairing support arm 3, the fairing support arm 3, under the action of the open-state limit stop 8 or the closed-state limit stop 7, is unable to continue rotating, at this moment, the locking device 9 continues rotating the rolling wheel assembly 92 to overcome spring force and thus being compressed. When the locking device 9 rotates to be perpendicular to (i.e. the critical point of mechanical “dead point”) the fairing support arm 3, at this moment, the spring 93 of the locking device 9 is compressed the shortest, the locking device 9 continues rotating, the rolling wheel assembly 92 of the locking device 9 continues rolling in the fairing support arm 3, and the spring 93 is released, at this moment, the angle between the locking device 9 and the fairing support arm 3 is less than 90 degrees, thus generating a mechanical self-lock angle, giving play to self-locking action, locking the opening/closing mechanism and holding it at the established state.

For convenience of manual unlocking, the lower end of the cylinder body 91 of the locking device is provided with a connector for manual unlocking and manual locking, both of which are operated through the connector; the manual unlocking and locking of the opening/closing mechanism can be achieved by revolving the locking device by an Allen wrench; both the manual unlocking and the manual locking are simple for operation.

The specific working process of the opening/closing mechanism in the present invention is as below: if the fairing 2 is going to be open, the powered push cylinder 4 pushes the locking device 9 to rotate, at this moment, the rolling wheel assembly 92 rolls in the fairing support arm 3, simultaneously driving the fairing support arm 3 to rotate around the rotating shaft 5; when the fairing 2 rotates to the open-state, which is driven by the fairing support arm 3, the fairing support arm 3, under the action of the open-state limit stop 8, is unable to continue rotating, at this moment, the locking device 9 continues rotating the rolling wheel assembly 92 to overcome spring force and thus being compressed. When the locking device 9 rotates to be perpendicular to (i.e. the critical point of mechanical “dead point”) the fairing support arm 3, at this moment, the spring 93 of the locking device 9 is compressed the shortest, the locking device 9 continues rotating, the rolling wheel assembly 92 of the locking device 9 continues rolling in the fairing support arm 3, and the spring 93 is released, at this moment, the angle between the locking device 9 and the fairing support arm 3 is less than 90 degrees, thus generating a mechanical self-lock angle, giving play to self-locking action, locking the opening/closing mechanism and holding it at the open position.

If the fairing 2 is going to be closed, the powered push cylinder 4 pulls back the locking device 9 to rotate, at this moment, the rolling wheel assembly 92 rolls in the fairing support arm 3, simultaneously driving the fairing support arm 3 to rotate around the rotating shaft 5; when the fairing 2 rotates to the closed-state, which is driven by the fairing support arm 3, the fairing support arm 3, under the action of the closed-state limit stop 7, is unable to continue rotating, at this moment, the locking device 9 continues rotating the rolling wheel assembly 92 to overcome spring force and thus being compressed. When the locking device 9 rotates to be perpendicular to (i.e. the critical point of mechanical “dead point”) the fairing support arm 3, at this moment, the spring 93 of the locking device 9 is compressed the shortest, the locking device 9 continues rotating, the rolling wheel assembly 92 of the locking device 9 continues rolling in the fairing support arm 3, and the spring 93 is released, at this moment, the angle between the locking device 9 and the fairing support arm 3 is less than 90 degrees, thus generating a mechanical self-lock angle, giving play to self-locking action, locking the opening/closing mechanism and holding it at the closed position.

Embodiment 2: different from Embodiment 1, in Embodiment 2, for realization of the rolling connection between the locking device 9 and the fairing support arm 3 and giving play to self-locking function, the locking device 9 comprises a cylinder body 91, in which a rolling wheel assembly 92 and a spring 93 are precompressed; one end of the cylinder body precompressed with the rolling wheel assembly is in rolling connection with the fairing support arm by means of the rolling wheel assembly, the rolling wheel assembly can roll in the fairing support arm, while the underneath of the wheel of the rolling wheel assembly is connected with the powered push cylinder.

Embodiment 3: different from Embodiment 1, in Embodiment 3, there are two rotating shafts 5 arranged on both sides of the baseplate 1; the two rotating shafts 5 are respectively sleeved at one end of the fairing support arm 3 on the same side, while the other end of the fairing support arm 3 is connected with the fairing 2 by means of the fairing mounting base 6.

Embodiment 4: different from Embodiment 3, in Embodiment 4, for realization of the rolling connection between the locking device 9 and the fairing support arm 3 and giving play to self-locking function, the locking device 9 comprises a cylinder body 91, in which a rolling wheel assembly 92 and a spring 93 are precompressed; one end of the cylinder body precompressed with the rolling wheel assembly is in rolling connection with the fairing support arm by means of the rolling wheel assembly, the rolling wheel assembly can roll in the fairing support arm, while the wheel underneath of the rolling wheel assembly is connected with the powered push cylinder.

what is claimed is:

1. An opening/closing mechanism equipped with a self-lock device, comprising a baseplate, a fairing, a fairing support arm, and a powered push cylinder; wherein the baseplate is provided with a rotating shaft, one end of the fairing support arm is sleeved on the rotating shaft, while the other end is connected with the fairing by means of a fairing mounting base; the baseplate is provided with a closed-state limit stop and an open-state limit stop; a locking device is arranged between the fairing support arm and the powered push cylinder, one end of the said locking device can move in the sliding groove of the fairing support arm, while the other end is installed on the powered push cylinder; in the opening or closing process of the opening/closing mechanism, the locking device moves and forms a mechanism dead point with the fairing support arm; in the locking process, a part of the locking device goes across the mechanism dead point and is mechanically limited, and in the unlocking process, the locking device goes across the mechanism dead point from reversed direction.

2. The opening/closing mechanism equipped with a self-lock device according to claim 1, wherein the locking device comprises a cylinder body, in which a rolling wheel assembly and a spring are precompressed.

3. The opening/closing mechanism equipped with a self-lock device according to claim 2, wherein the one end of the cylinder body precompressed with a rolling wheel assembly is in rolling connection with the fairing support arm by means of the rolling wheel assembly, the rolling wheel assembly can roll in the fairing support arm, while the other end of the cylinder body is connected with the powered push cylinder.

4. The opening/closing mechanism equipped with a self-lock device according to claim 2, wherein the end of the cylinder body precompressed with a rolling wheel assembly is in rolling connection with the fairing support arm by means of the rolling wheel assembly, the rolling wheel assembly can roll in the fairing support arm, while the underneath of the wheel of the rolling wheel assembly is connected with the powered push cylinder.

5. The opening/closing mechanism equipped with a self-lock device according to claim 2, wherein the lower end of the cylinder body is provided with a connector for manual release and manual locking, both of which are operated through the connector.

6. The opening/closing mechanism equipped with a self-lock device according to claim 1, wherein only one rotating shaft is positioned, which is in the center of the baseplate.

7. The opening/closing mechanism equipped with a self-lock device according to claim 1, wherein two rotating shafts are positioned, which are on both sides of the baseplate.
